(19) United States
(12) Patent Application Publication
(10) Pub. No.: US 2025/0105570 A1
(43) Pub. Date: Mar. 27, 2025

(54) CABLE CONNECTOR

(71) Applicant: TAIWAN MASTER HILL TECHNOLOGY CO., LTD., Yunlin County (TW)

(72) Inventor: CHANG-CHI LEE, Yunlin County (TW)

(73) Assignee: TAIWAN MASTER HILL TECHNOLOGY CO., LTD., Yunlin County (TW)

(21) Appl. No.: 18/423,222

(22) Filed: Jan. 25, 2024

(30) Foreign Application Priority Data
Sep. 21, 2023 (TW) 112210222

(51) Int. Cl. H01R 35/04; H01R 13/504; H01R 13/58

(52) U.S. Cl. CPC H01R 35/04; H01R 13/504; H01R 13/5845

(57) ABSTRACT

A cable connector includes a shielding shell, a rotating head, and a plurality of wires, wherein the rotating head is pivotally connected to the shielding shell. The rotating head has an enclosing body formed by injection molding. The enclosing body is a solid structure and encloses a circuit board and a connector that are electrically connected to each other. The connector is partially exposed outside the enclosing body. The wires pass through the shielding shell, wherein an end of each wire passes through the enclosing body and is connected to the circuit board. In this way, when the rotating head is pivoted, the wires are not easy to be torn off, which ensures a good electrical connection to enhance the reliability and the stability of the data transmission.

### BACKGROUND OF THE INVENTION

### Technical Field

The present invention relates generally to a data cable, and more particularly to a cable connector of a data cable.

### Description of Related Art

An existing data cable used for electrical connection between two electronic devices and equipped with the function of data transmission mainly includes a cable connector at each end of a cable. The cable connector can be, for example, a Type-C connector or a USB connector according to the demand. Commonly, the cable connector is directly connected to one end of the cable in a one-piece molding. However, a wire, which passes through an inner portion of the cable and is used to be electrically connected to the cable connector, is likely to be electrically disconnected from the cable connector or even to be torn due to a connection part between the cable connector and the cable being frequently bent.

In order to solve the aforementioned problems, there is a kind of data cable of which the cable connector is designed to be pivotable, that is, the cable connector is pivotally connected to an end of the cable, and a plurality of round electrodes are disposed inside the cable connector in advance; the round electrodes are designed in a concentric manner and have different diameters; a plurality of flexible pins is provided at the end of the cable and is respectively and electrically connected to a wire, wherein the flexible pins are respectively in contact with one of the round electrodes; in this way, when the cable connector is deflected for any reason, the cable connector can still be electrically connected to the cable to transmit data by the flexible pins being in contact with the round electrodes. Although the aforementioned structure can solve the potential problems of the one-piece data cable, it is not easy to position and configure the round electrodes and the flexible pins in the tiny structure; besides, the flexible pins are in contact with the round electrodes in a “point” way; when the flexible pins have an elastic fatigue or deviation from a preset position, poor contact is easily resulted. Therefore, the reliability and the stability of the existing cable connector that is pivotable still have room for improvements.

### BRIEF SUMMARY OF THE INVENTION

In view of the above, the primary objective of the present invention is to provide a cable connector, which could ensure a good electrical connection to enhance the reliability and the stability of data transmission.

In order to achieve the above objective, the present invention provides a cable connector including a shielding shell, a rotating head, and a plurality of wires, wherein the rotating head includes an enclosing body pivotally connected to the shielding shell and has a connector; the enclosing body encloses a portion of the connector; the plurality of wires pass through the shielding shell, wherein an end of each of the plurality of wires passes through the enclosing body and is connected to the connector.

In one embodiment, the plurality of wires are magnet wires; the enclosing body is a solid structure formed by injection molding and encloses a portion of the plurality of wires.

The effect of the present invention is to strengthen the welding effect of the wires by enclosing the portion of the wires with the enclosing body, so that the wires are not easy to be torn off when the rotating head is pivoted.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the cable connector according to an embodiment of the present invention;

FIG. 2 is an exploded view of the cable connector according to the embodiment of the present invention;

FIG. 3 is a schematic plan view, showing the internal components of the cable connector;

FIG. 4 is a right-side view of the cable connector shown in FIG. 1;

FIG. 5 is a schematic view, showing a section of a part of the cable connector shown in FIG. 1;

FIG. 6 is a schematic side view, showing the first wire group and the second wire group connected to the enclosing body of the cable connector shown in FIG. 1;

FIG. 7 is a schematic top view, showing the position of the rotating head of the cable connector shown in FIG. 1 in the normal state;

FIG. 8 is similar to FIG. 7, showing the position of the rotating head of the cable connector after being pivoted; and

FIG. 9 is a schematic plan view of the cable connector according to another embodiment of the present invention.

### DETAILED DESCRIPTION OF THE INVENTION

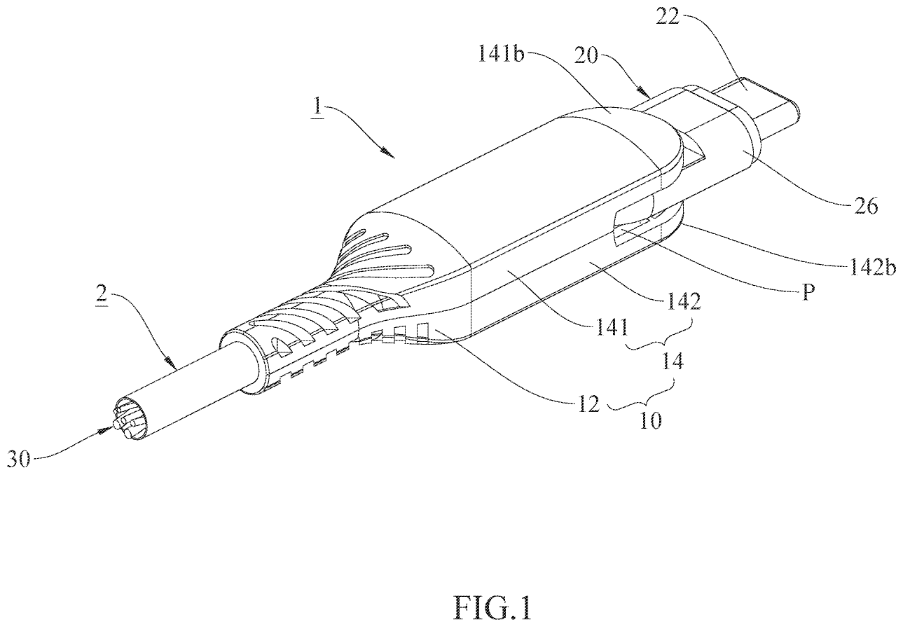

A cable connector 1 according to an embodiment of the present invention is illustrated in FIG. 1 and is connected to an end of a cable 2. The cable connector 1 includes a shielding shell 10, a rotating head 20, and a plurality of wires 30.

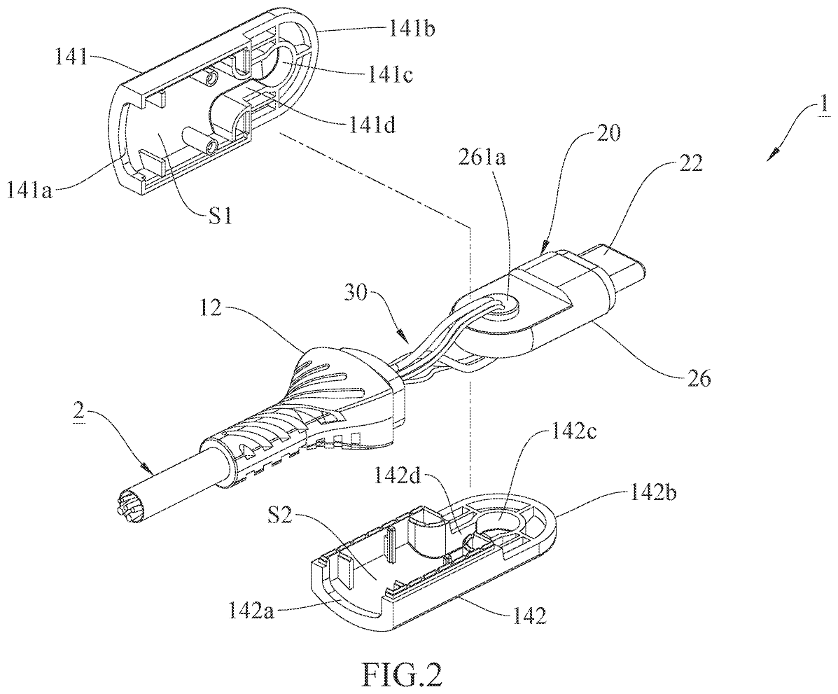

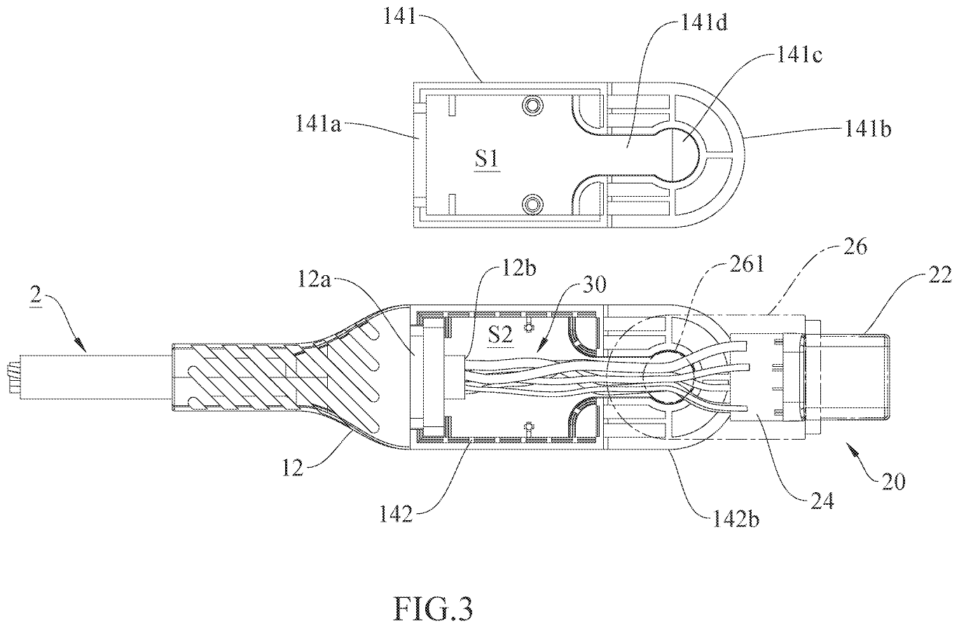

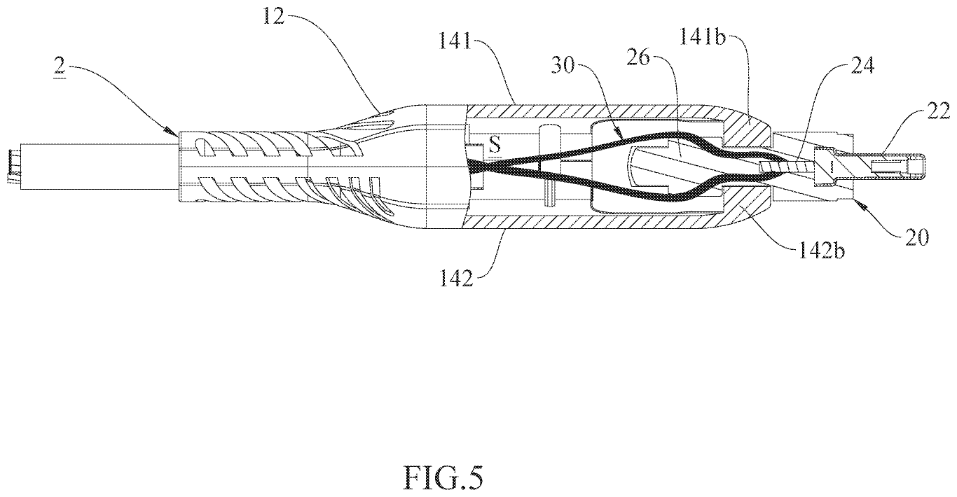

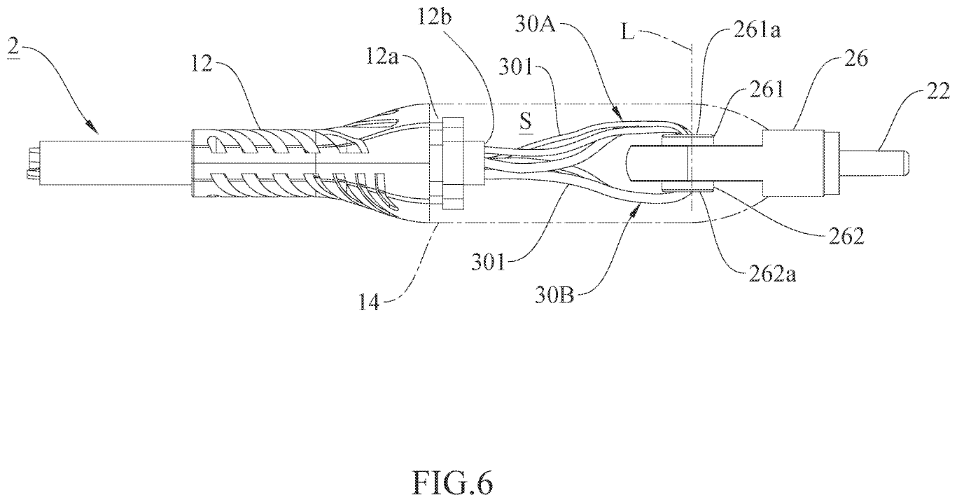

Referring to FIG. 2 to FIG. 4, the shielding shell 10 includes a shield 12 and a housing 14, wherein an end of the shield 12 is connected to the cable 2 and another end of the shield 12 forms a neck 12a. The housing 14 is connected to the another end of the shield 12 having the neck 12a, and a space S is formed inside the housing 14 (referring to FIG. 5 and FIG. 6). A front end of the housing 14 has an opening P communicating with the space S. In the current embodiment, the housing 14 includes an upper housing 141 and a lower housing 142 that could be engaged with each other; two sunken areas S1, S2 are respectively provided on an inner surface of the upper housing 141 and an inner surface of the lower housing 142. Two fitting ports 141a, 142a are respectively provided on an end of the upper housing 141 and an end of the lower housing 142; two tongue portions 141b, 142b are respectively formed by protruding outwardly from another end of the upper housing 141 and another end of the lower housing 142 that are opposite to the fitting ports 141a, 142a.

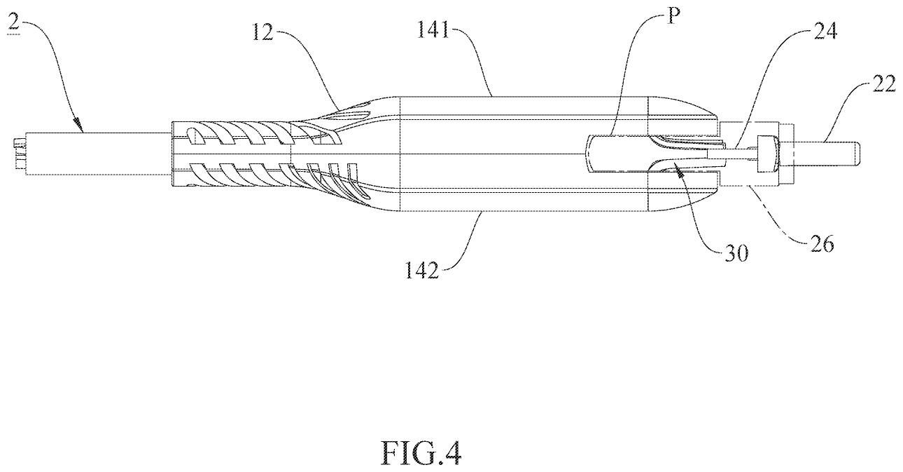

When the upper housing 141 is engaged with the lower housing 142, the sunken areas S1, S2 jointly constitute the space S inside the housing 14. The fitting ports 141a, 142a are embedded in the neck 12a of the shield 12, respectively, so that the housing 14 in the engaged state could not be withdrawn relative to the shield 12; the opening P of the front end of the housing 14 is formed between an inner surface of the tongue portion 141b and an inner surface of the tongue portion 142b (referring to FIG. 4). In addition, two grooves 141c, 142c are respectively formed by recessing into the inner surface of the upper housing 141 and the inner surface of the lower housing 142 that have the tongue portions 141b, 142b. Two communicating channels 141d, 142d are respectively formed by recessing into the inner surface of the upper housing 141 and the inner surface of the lower housing 142 that have the tongue portions 141b, 142b. Each of the grooves 141c, 142c has a circular contour. The communicating channel 141d is adapted to communicate the sunken area S1 with the groove 141c, and the communicating channel 142d is adapted to communicate the sunken area S2 with the groove 142c.

The rotating head 20 includes a connector 22, a circuit board 24, and an enclosing body 26. The connector 22 is not limited to a Type-C connector or a USB connector. The connector 22 is electrically connected to the circuit board 24. The enclosing body 26 is made of insulation material, wherein a part of the enclosing body 26 is located in the opening P and is pivotally connected to the housing 14 of the shielding shell 10, and another part of the enclosing body 26 encloses the circuit board 24 and a portion of the connector 22, such that the portion of the connector 22 is located outside of the housing 14. Referring to FIG. 5 to FIG. 6, in the current embodiment, the enclosing body 26 is a solid structure formed by injection molding, and the part of the enclosing body 26 pivotally connected to the housing 14 of the shielding shell 10 is formed with two protrusions 261, 262 that are cylindrical, wherein the two protrusions 261, 262 are set opposite to each other and located on the same axis L. During assembling, the tongue portion 141b of the upper housing 141 and the tongue portion 142b of the lower housing 142 jointly clamp the enclosing body 26, the protrusion 261 of the enclosing body 26 is embedded in the groove 141c of the upper housing 141, and the protrusion 262 of the enclosing body 26 is embedded in the groove 142c of the lower housing 142, so that the enclosing body 26 is pivotable around a pivot portion formed by the two protrusions 261, 262 within the opening P.

The wires 30 include power wires and signal wires. The wires 30 primarily pass through the cable 2, and a portion of the wires 30 passes out of an end surface 12b of the shield 12 of the shielding shell 10. In terms of structural relationship, an end of each of the wires 30 that passes out of the end surface 12b passes through the enclosing body 26 and is connected to the circuit board 24 in a welding manner to be electrically connected to a circuit of the circuit board 24. It should be noted that the enclosing body 26 of current embodiment is processed by injection molding to achieve the purpose of enclosing the circuit board 24 and the portion of the connector 22, so that the enclosing body 26 substantially encloses the portion of the wires 30. It is worth mentioning that in the current embodiment, the wires 30 are divided into two wire groups, namely a first wire group 30A and a second wire group 30B, and each of the wire groups includes a plurality of the wires 30, wherein the wires 30 of the first wire group 30A pass through a top surface 261a of the protrusion 261, and the wires 30 of the second wire group 30B pass through a bottom surface 262a of the protrusion 262; preferably, the wires 30 pass through a position of the top surface 261a (the bottom surface 262a) of the protrusion 261 (the protrusion 262) close to a center of the top surface 261a (the bottom surface 262a). In addition, in the current embodiment, a length of a wire segment 301 of the wires 30 from the end surface 12b of the shield 12 to a junction of the wires 30 passing through the top surface 261a (the bottom surface 262a) of the protrusion 261 (the protrusion 262) is longer than a shortest distance from the end surface 12b to the axis L. In order to satisfy the aforementioned relationship, the wire segment 301 of the wires 30 from the end surface 12b to the junction is not a straight wire segment but is an arced wire segment and falls within the space S and the communicating channels 141d, 142d. It is further noted that the aforementioned wires 30 could be magnet wires or electronic wires & cables. In the current embodiment, the wires 30 are magnet wires as an example.

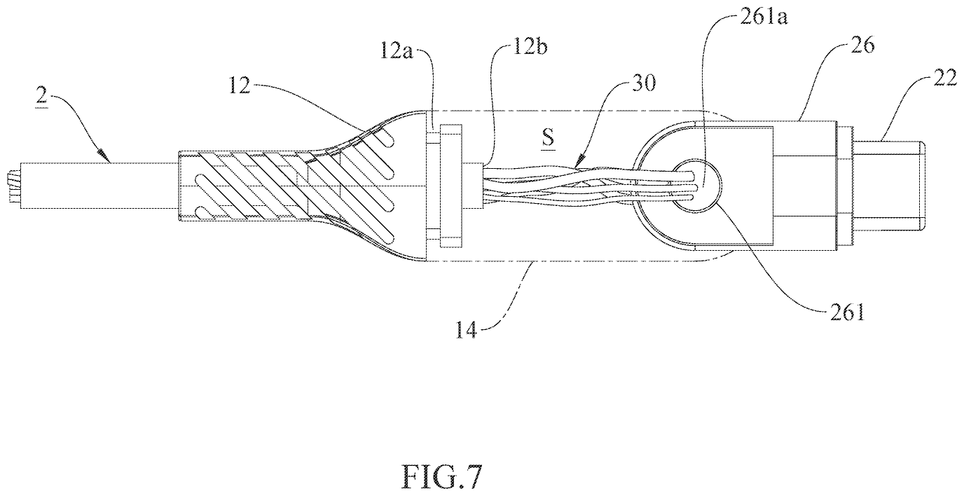

FIG. 7 shows that the cable connector 1 is in a normal state, wherein the normal state refers to a state in which the rotating head 20 is not pivoted, that is, the connector 22 of the rotating head 20 is located in a direction of the cable 2 that extends straightly.

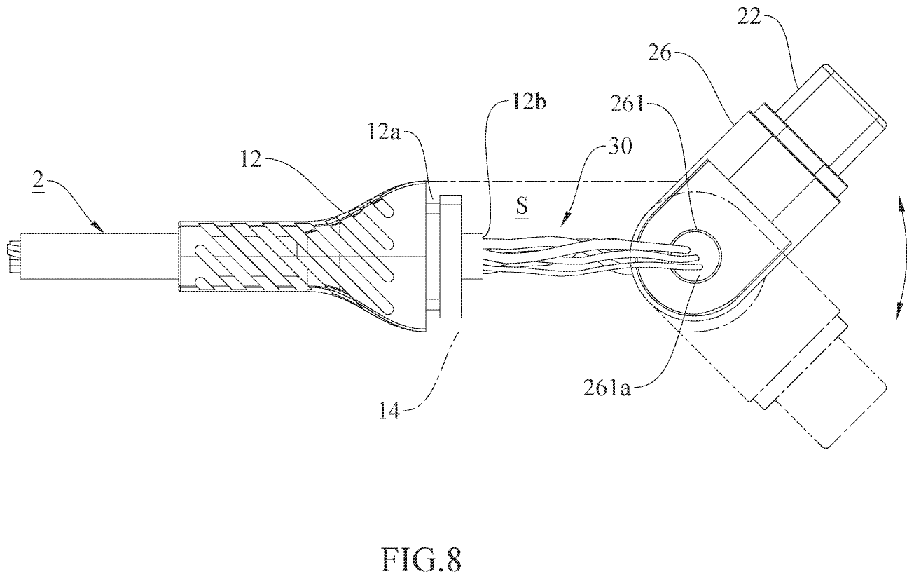

As shown in FIG. 8, the wire segment 301 of the wires 30 exposed between the end surface 12b and the top surface 261a (the bottom surface 262a) of the protrusion 261 (the protrusion 262) is not a straight line design and the position of the enclosing body 26 being passed by the wires 30 is the top surface 261a and the bottom surface 262a of the two protrusions 261, 262 that form the pivot portion, so that when the rotating head 20 of the cable connector 1 is pivoted relative to the shielding shell 10 according to the usage environment, the wires 30 would not be pulled excessively and could be moderately extended due to the reserved length of the wires 30; the enclosing body 26 encloses the portion of the wires 30 and the circuit board 24, so that the portion of the wires 30 welded to the circuit board 24 could not be easily torn. In this way, a good electrical connection could be ensured, thereby enhancing the reliability and the stability of the data transmission.

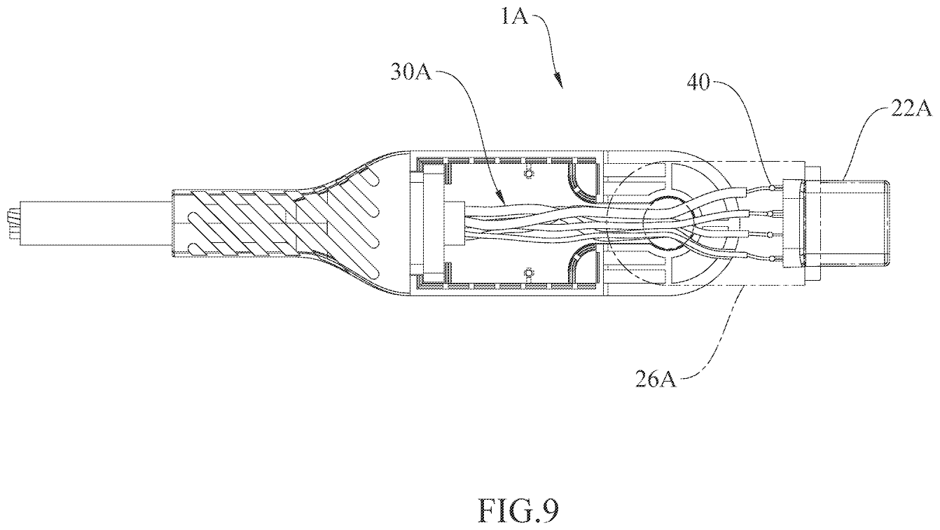

In the aforementioned embodiment, one end of the wires 30 is connected to the circuit board 24 to form a circuit connection with the connector 22. However, in other embodiments, the cable connector might not include the circuit board. A cable connector 1A according to another embodiment of the present invention is illustrated in FIG. 9, wherein each of a plurality of wires 30A is directly and electrically connected to a connector 22A through a welding point 40 at one end of each of the plurality of wires 30A after each of the plurality of wires 30A passes into an enclosing body 26A. In this way, a good electrical connection effect could be achieved and the reliability and the stability of the data transmission could be enhanced.

It must be pointed out that the embodiments described above are only some preferred embodiments of the present invention. All equivalent structures which employ the concepts disclosed in this specification and the appended claims should fall within the scope of the present invention.

What is claimed is:

1. A cable connector, comprising:
a shielding shell;
a rotating head, comprising an enclosing body pivotally connected to the shielding shell and having a connector, wherein the enclosing body encloses a portion of the connector;
a plurality of wires, passing through the shielding shell, wherein an end of each of the plurality of wires passes through the enclosing body and is electrically connected to the connector.

2. The cable connector as claimed in claim 1, wherein the plurality of wires are magnet wires; the enclosing body is a solid structure formed by injection molding and encloses a portion of the plurality of wires.

3. The cable connector as claimed in claim 2, wherein the shielding shell comprises a shield and a housing; the housing is connected to the shield, wherein a space is formed inside the housing; a front end of the housing has an opening communicating with the space; the enclosing body has a pivot portion in the housing and is pivotable around the pivot portion within the opening; the connector is located outside the housing; the end of each of the plurality of wires passes through the shield and enters the pivot portion through the enclosing body; a wire segment of each of the plurality of wires corresponding to the space is not a straight wire segment.

4. The cable connector as claimed in claim 1, wherein the shielding shell comprises a shield and a housing; the housing is connected to the shield, wherein a space is formed inside the housing; a front end of the housing has an opening communicating with the space; the enclosing body has a pivot portion in the housing and is pivotable around the pivot portion within the opening; the connector is located outside the housing; the end of each of the plurality of wires passes through the shield and enters the enclosing body.

5. The cable connector as claimed in claim 4, wherein the shield has a neck; the housing comprises an upper housing and a lower housing; an inner surface of the upper housing and an inner surface of the lower housing respectively have a sunken area; an end of the upper housing and an end of the lower housing respectively have a fitting port, and another end of the upper housing and another end of the lower housing are protruded outwardly to form a tongue portion, respectively; when the upper housing and the lower housing are engaged with each other, the two sunken areas jointly form the space, the two fitting ports are embedded in the neck of the shield, and the opening is formed between the two tongue portions.

6. The cable connector as claimed in claim 5, wherein two grooves are respectively formed on an inner surface of the tongue portion of the upper housing and an inner surface of the tongue portion of the lower housing; two communicating channels are respectively formed on the inner surface of the tongue portion of the upper housing and the inner surface of the tongue portion of the lower housing; each of the two grooves communicates with each of the two sunken areas through each of the two communicating channels; the enclosing body has two protrusions arranged opposite to each other; the two protrusions constitute the pivot portion and are respectively embedded in one of the two grooves.

7. The cable connector as claimed in claim 6, the enclosing body is a solid structure formed by injection molding; a portion of each of the plurality of wires passes through the two protrusions, and another portion of each of the plurality of wires is located between the space and the two communicating channels.

8. The cable connector as claimed in claim 7, a wire segment of each of the plurality of wires that passes out of an end surface of the shield to a junction of the plurality of wires passing through the corresponding protrusion is not a straight wire segment.

9. The cable connector as claimed in claim 1, wherein the plurality of wires are magnet wires.

10. The cable connector as claimed in claim 1, wherein the wires are electronic wires & cables.

11. The cable connector as claimed in claim 1, wherein the rotating head comprises a circuit board electrically connected to the connector; the enclosing body encloses the circuit board, and the end of each of the plurality of wires is connected to the circuit board.

12. The cable connector as claimed in claim 1, wherein the end of each of the plurality of wires is electrically connected to the connector via a welding point.
